(19) United States
(12) Patent Application Publication
(10) Pub. No.: US 2005/0125649 A1
(43) Pub. Date: Jun. 9, 2005

(54) Method for updating firmware

(75) Inventors: Ming-Yih Lu, Taipei City (TW); Huang-Lung Tzeng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/998,639

(22) Filed: Nov. 30, 2004

(30) Foreign Application Priority Data
Dec. 5, 2003 (TW) 092134438

(51) Int. Cl. G06F 9/00

(52) U.S. Cl. 713/1

(57) ABSTRACT

A method for updating firmware in a microprocessor in a computer system is disclosed. The microprocessor has an application memory, a load memory and a cache, and a firmware updating program and a firmware testing program are stored in the load memory. Every time the computer system is turned on, the firmware testing program checks whether the firmware is correct; if the firmware is not correct, a user interface can be used to inform the user and the firmware updating process is repeated until the firmware is updated. As a result, the firmware updating process is ensured to be complete and correct to avoid halting of the computer system due to faulty firmware.

### BACKGROUND OF THE INVENTION

1. Field of the Invention

The present invention relates to a method for updating firmware and, more particularly, to a method for updating firmware in a microprocessor.

2. Description of the Related Art

In a computer system, a microprocessor is used for executing a number of processes, and the microprocessor usually first downloads firmware stored in a storage device (such as ROM) as a driver so as to communicate with a peripheral electrical device. If the firmware is incorrect, the microprocessor will be unable to communicate with the peripheral electrical device. Fortunately, under normal operations, the firmware is set by the manufacturer and is correct and properly executable. As shown in FIG. 1, an integrated microprocessor 10 comprises an application memory 11, a load memory 12, and a cache 13. The integrated microprocessor 10 can access an external memory 14, and is capable of exchanging data with a peripheral electrical device 15. The load memory 12 is adapted to store a firmware updating program. When a user wants to update the firmware, the firmware updating program sequentially reloads a new firmware into the application memory. After the computer system is reset, the integrated microprocessor 10 loads the firmware stored in the application memory 11 so that the integrated microprocessor 10 can communicate with the external memory 14 and the peripheral electrical device 15. The cache 13 is adapted to store temporary values or flags, and the flags are adapted to provide various configurations for the integrated microprocessor 10.

For a new functional improvement or debugging procedure, the user needs to execute the firmware updating program to obtain the new or improved firmware, and then the integrated microprocessor 10 executes the firmware updating program to update the firmware. However, during the firmware updating process executed by the firmware updating program, if an unexpected condition occurs, such as a shutting down of the computer system, a break in data transmission, or an non-executable code of the new or improved firmware, the integrated microprocessor 10 cannot complete the entire firmware updating process, and could end up storing incomplete or incorrect firmware. Consequently, when the computer system is rebooted, the integrated microprocessor 10 loads the incomplete or incorrect firmware, and then the computer system halts. The user will be unable to determine why the computer system has shut down.

Therefore, it is desirable to provide a method for updating firmware to mitigate and/or obviate the aforementioned problems.

### SUMMARY OF THE INVENTION

A main objective of the present invention is to provide a method for updating firmware which can repeat a firmware updating process if the process fails until the firmware is updated.

Another objective of the present invention is to provide a method for updating firmware which can enable the microprocessor to inform a user to repeat the firmware updating process if the process fails.

In order to achieve the above-mentioned objective, a method is disclosed for updating firmware in a microprocessor in a computer system, wherein the microprocessor has an application memory, a load memory and a cache, the method comprising: (A) switching on the computer system; (B) reading and executing the firmware stored in the load memory; (C) determining whether an update command exists; if the update command exists, then executing step (I); (D) determining whether an firmware error command exists; if the firmware error command exists, then executing step (I); (E) determining whether the firmware stored in the application memory is correct; if the firmware stored in the application memory is not correct, then executing step (K); (F) reading and executing the firmware stored in the application memory; (G) determining whether the firmware stored in the application memory requires updating; if the firmware stored in the application memory does not require updating, then repeating step (G); (H) storing an update command and executing step (B); (I) executing a firmware updating process; (J) determining whether the firmware stored in the application memory is correct; if the firmware stored in the application memory is correct, then executing step (L); (K) storing the firmware error command and executing step (B); and (L) clearing the update command and firmware error command and executing step (B); wherein the update command and the firmware error command are stored in the cache.

Other objects, advantages, and novel features of the invention will become more apparent from the following detailed description when taken in conjunction with the accompanying drawings.

### BRIEF DESCRIPTION OF THE DRAWINGS

FIG. 1 is a functional block drawing of a computer system; and

FIG. 2 is a flowchart of the method of updating firmware according to the present invention.

### DETAILED DESCRIPTION OF THE PREFERRED EMBODIMENT

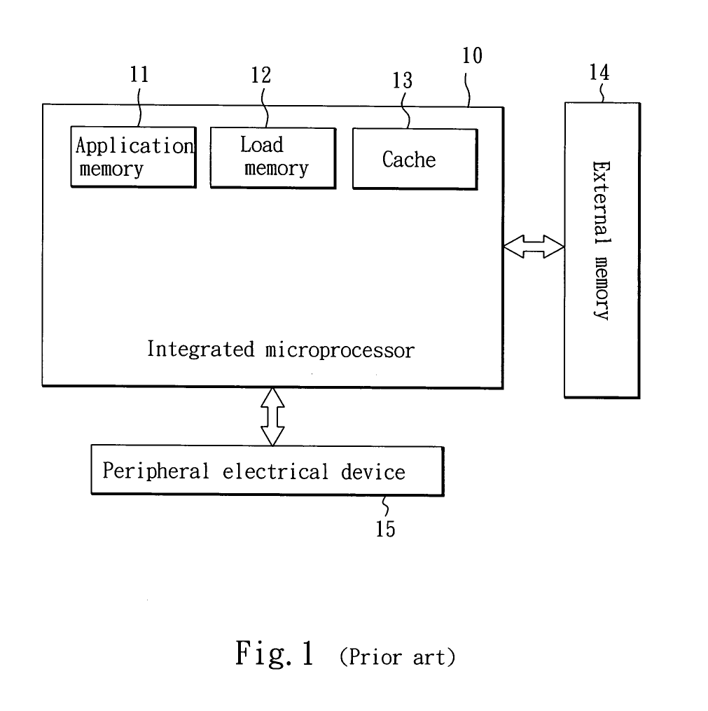

In FIG. 1, a computer system stores firmware in a load memory 12; the firmware includes: a firmware updating program and a firmware testing program. The firmware testing program is used for checking whether firmware stored in an application memory 11 is correct, and it utilizes a checksum to determine whether the firmware is correct. Furthermore, the user can also add pseudo code into the firmware program code so that the firmware testing program can perform a check upon the firmware program code itself.

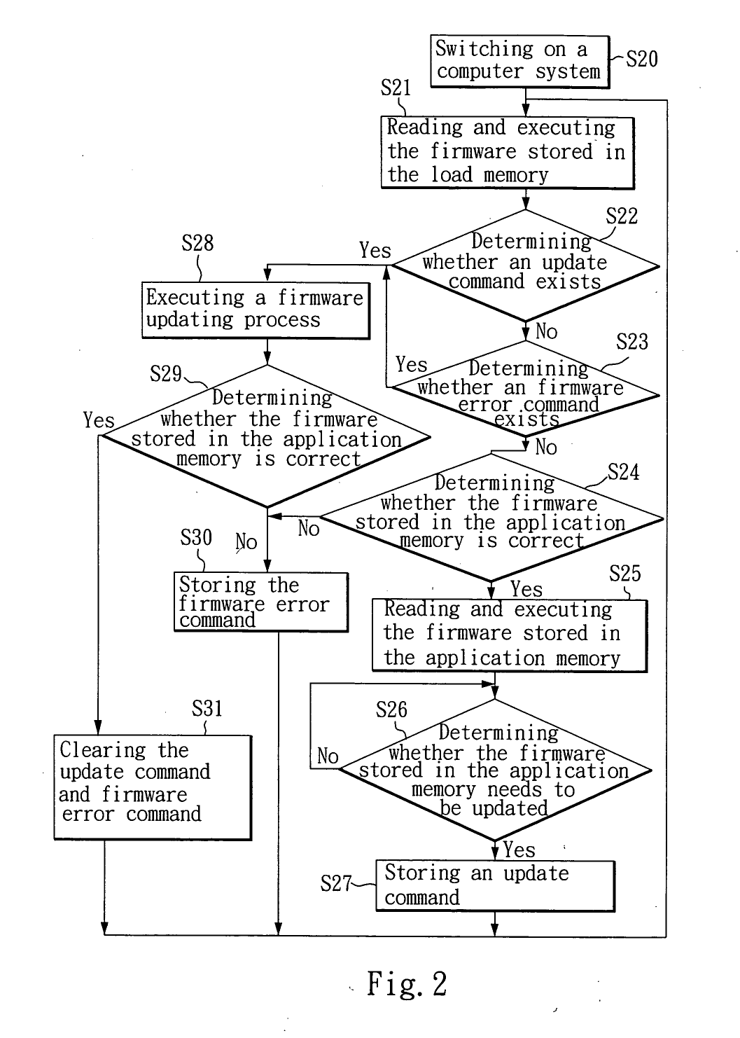

Please refer to FIG. 2. The method of updating firmware according to the present invention can be performed with an integrated microprocessor 10 including the application memory 11, the load memory 12, and a cache 13. The method of updating firmware comprises:

Step S20: switching on the computer system.

Step S21: reading and executing the firmware stored in the load memory 12. Every time the computer system is switched on, the integrated microprocessor 10 reads and executes the firmware stored in the load memory 12.

Step S22: determining whether an update command exists. The integrated microprocessor 10 checks flags stored in the cache 13 to determine whether an update command exists. One of the flags on the cache 13 is an update flag with a default value of 0; when the default value of the update flag is 1, step S28 is executed; otherwise step S23 is executed.

Step S23: determining whether an firmware error command exists. The integrated microprocessor 10 checks flags in the cache 13 to determine whether the firmware error command exists. Another flag on the cache 13 is an firmware error flag with a default value of 0; when the default value of the firmware error flag is 1, step S28 is executed; otherwise step S24 is executed.

Step S24: determining whether the firmware stored in the application memory is correct. The integrated microprocessor 10 reads and executes the firmware testing program to check the firmware stored in the application memory 11; if the firmware program code is correct, the default value of the error flag will be unchanged and step S25 is executed; if the firmware program code is incorrect, then step S30 is executed.

Step S25: reading and executing the firmware stored in the application memory 11. The integrated microprocessor 10 reads the correct firmware stored in the application memory 11 and executes it.

Step S26: determining whether the firmware stored in the application memory needs to be updated. If a user wants to update the firmware, step S27 is executed; otherwise step S26 is repeated.

Step S27: storing an update command. The integrated microprocessor 10 changes the value of the update flag from 0 to 1, stores the update command, and executes step S21.

Step S28: executing a firmware updating process. The integrated microprocessor 10 reads the firmware updating program stored in the load memory 12 to perform the firmware updating process and then executes step S29. Accordingly, the user needs to provide a new firmware program so that the firmware updating program can finish the firmware updating process.

Step S29: determining whether the firmware stored in the application memory is correct. The integrated microprocessor 10 reads the firmware testing program stored in the load memory 12 to determine whether the firmware stored in the application memory is correct. If the firmware is correct, step S31 is executed; otherwise step S30 is executed.

Step S30: storing the error command. The integrated microprocessor 10 changes the value of the error flag from 0 to 1, stores the error command, and executes step S21.

Step S31: clearing the update command and error command. The integrated microprocessor 10 changes the values of the update flag and the error flag from 1 to 0, thereby clearing the update command and the error command, and then executes step S21.

Consequently, every time the computer system is turned on, the firmware testing program checks whether the firmware is correct; if the firmware is not correct, a user interface can be used to inform the user and step S28 is executed to update the firmware. As a result, the firmware updating process is ensured to be complete and correct to avoid halting of the computer system due to faulty firmware.

Although the present invention has been explained in relation to its preferred embodiment, it is to be understood that many other possible modifications and variations can be made without departing from the spirit and scope of the invention as hereinafter claimed.

1. A method for updating firmware in a microprocessor in a computer system, the microprocessor having an application memory, a load memory and a cache, the method comprising the steps of:
(A) switching on the computer system;
(B) reading and executing the firmware stored in the load memory;
(C) determining whether an update command exists, if the update command exists, then executing step (1);
(D) determining whether an firmware error command exists, if the error command exists, then executing step (I);
(E) determining whether the firmware stored in the application memory is correct, if the firmware stored in the application memory is not correct, then executing step (K);
(F) reading and executing the firmware stored in the application memory;
(G) determining whether the firmware stored in the application memory requires updating, if the firmware stored in the application memory does not require updating, then repeating step (G);
(H) storing an update command and executing step (B);
(I) executing a firmware updating process;
(J) determining whether the firmware stored in the application memory is correct, if the firmware stored in the application memory is correct, then executing step (L);
(K) storing the firmware error command and executing step (B); and
(L) clearing the update command and firmware error command and executing step (B);
wherein the update command and the error command are stored in the cache.

2. The method as claimed in claim 1, wherein the update command and firmware error command are respective flags stored in the cache.
